(19) United States
(12) Patent Application Publication
(10) Pub. No.: US 2011/0119615 A1
(43) Pub. Date: May 19, 2011

(54) Adaptive Data Loader

(75) Inventors: Pavel Cisler, Los Gatos, CA (US); Loic Vandereyken, Palo Alto, CA (US); David Hart, San Francisco, CA (US); Peter McInerney, Cupertino, CA (US)

(73) Assignee: APPLE INC., Cupertino, CA (US)

(21) Appl. No.: 12/619,342

(22) Filed: Nov. 16, 2009

(51) Int. Cl. G06F 3/048

(52) U.S. Cl. 715/772; 715/764

(57) ABSTRACT

Methods, systems, and apparatus, including computer programs encoded on a computer storage medium, for presenting data. In one aspect, a method includes receiving a request for data; submitting the request while maintaining a currently displayed user interface; determining whether a specified amount of the data has been received within a threshold delay period; if the data has been received within the threshold delay period, displaying a new user interface including representations of a portion of the received data; and if the data has not been received within the threshold delay period, displaying a placeholder user interface.

### TECHNICAL FIELD

This specification relates to user interfaces for presenting data.

### BACKGROUND

Conventional computing systems display data using graphical user interfaces drawn on a display device. For example, the graphical user interfaces can present information regarding file system structures, content for various applications (e.g., documents, mail), Web pages, and other data.

In some conventional systems when new data is to be presented (e.g., in response to a user request), the system fetches the data, processes the fetched data (e.g., identifies location and arrangement of objects or items to present), and then displays representations of the data to the user in a newly drawn user interface. For example, when interacting with a user interface window representing a file system, a user can select a folder to open. The system then fetches the data and displays the contents of the folder in a user interface window.

In some conventional systems, once a selection has been made within a currently presented user interface (which triggers a fetch of data and a newly drawn user interface), the currently presented user interface is maintained and locked until the new user interface is drawn with the fetched data. If the delay is long, the user can not interact with the user interface and the lag in responsiveness may appear to the user as a system error. In some other conventional systems, the system immediately draws a placeholder user interface when the system begins fetching the data. However, this requires an additional drawing operation and can generate a noticeable flash when the new user interface including the fetched data is drawn over the placeholder user interface.

### SUMMARY

This specification describes technologies relating to user interfaces for presenting data.

In general, one aspect of the subject matter described in this specification can be embodied in methods that include the actions of receiving a request for data; submitting the request while maintaining a currently displayed user interface; while maintaining the currently displayed user interface, determining whether a specified amount of the data has been received within a threshold delay period; if the data has been received within the threshold delay period, displaying a new user interface including representations of a portion of the received data; and if the data has not been received within the threshold delay period, displaying a placeholder user interface. Other embodiments of this aspect include corresponding systems, apparatus, and computer program products.

These and other embodiments can optionally include one or more of the following features. The method further includes drawing representations of received data to the placeholder user interface as the data is received. The method further includes determining whether the data has been received within a second threshold delay period; and if the data has not been received within the second threshold delay period, drawing a second placeholder user interface replacing the first placeholder user interface. The threshold delay period has a minimum value based on display hardware constraints. The placeholder user interface is a blank screen. The placeholder user interface includes a partial display of the user interface to be drawn for representing the received data. The placeholder user interface includes placeholders for icons, where the data including the icons has not been received. The placeholders for icons include outlines of items in the placeholder user interface to be represented by the corresponding icons. The partially drawn user interface includes representations of items that are user-interactable. A user selection of an item represented in the partially drawn user interface cancels the pending request for data and initiates a new request for displaying data associated with the selection. The placeholder user interface or the new user interface are presented without a flicker effect caused by transitioning from the currently displayed user interface.

In general, one aspect of the subject matter described in this specification can be embodied in methods that include the actions of presenting a user interface including one or more folder icons; receiving a request to present the contents of a folder represented by one of the one or more folder icons; fetching data for displaying the contents of the folder while maintaining the displayed user interface; while maintaining the displayed user interface, determining whether a specified amount of the data has been received within a threshold time; if the data has been received within the threshold time, displaying a new user interface including representations of the folder contents viewable within the dimensions of the new user interface; and if the data has not been received within the threshold time, displaying a placeholder user interface. Other embodiments of this aspect include corresponding systems, apparatus, and computer program products.

Particular embodiments of the subject matter described in this specification can be implemented so as to realize one or more of the following advantages. User interface transitions are optimized to present placeholder user interfaces only in particular circumstances. Flicker effects of rapid user interface transitions can be prevented. Users can interact with placeholder user interfaces, allowing users to select items more quickly without waiting for all of the data to be fetched. Additionally, interacting within the placeholder user interface reduces processing when a user selects another item since any remaining data associated with a loading user interface no longer needs to be fetched once the user navigates away. The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a flowchart showing an example method for presenting retrieved data.

FIGS. 2-4 are block diagrams of example pipelines for displaying data.

FIG. 5 is an example screenshot of a user interface from which a request for data is made.

FIG. 6 is an example screenshot of a placeholder user interface.

FIG. 7 is an example screenshot of a placeholder user interface including partial content.

FIG. 8 is an example screenshot of a user interface including fetched data.

FIG. 9 is an example system architecture.

Like reference numbers and designations in the various drawings indicate like elements.

### DETAILED DESCRIPTION

Systems and methods are described for displaying requested data to a user. For example, a user interface can display a representation of a computer file system. The file system, e.g., a hierarchal file system, can display items including folders, files, application, and other data as icons. In some scenarios, selecting an item results in the display of additional data. For example, when a user opens a folder, the user interface is updated or redrawn to present the contents of the folder (e.g., item names, icons).

In particular, when a data request is received (e.g., based on a user input or selection or based on a system or application process), a currently displayed interface is maintained for a specified delay period. If the data is not received within the specified delay period, a placeholder user interface can be displayed. If the data is received within the specified delay period, the currently displayed user interface is updated or redrawn to reflect the fetched data (e.g., to display icons, names, etc. fetched for a folder).

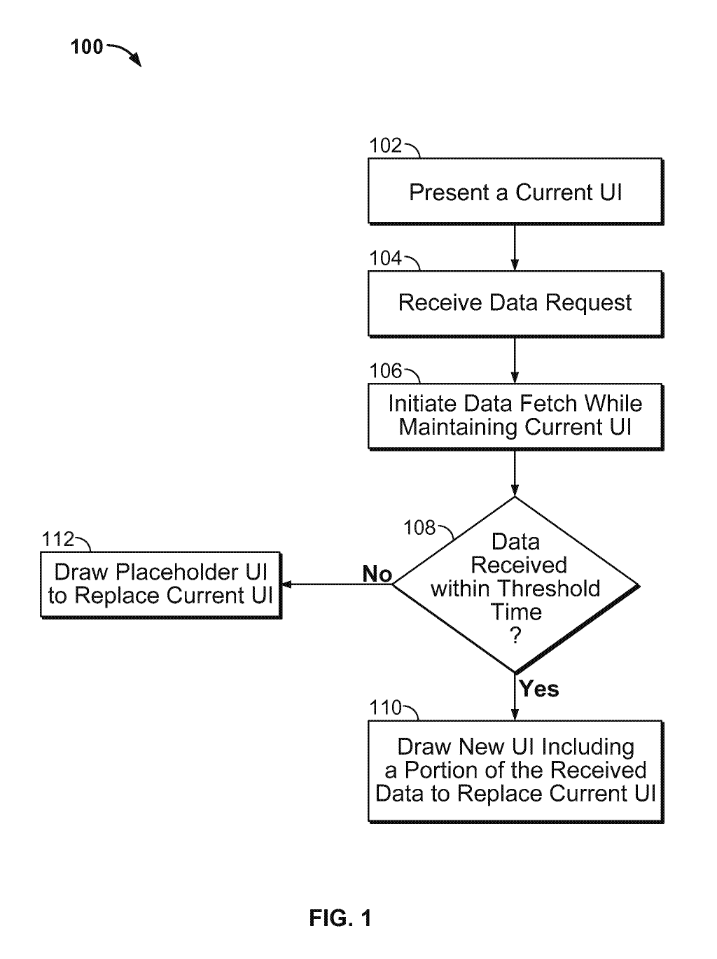

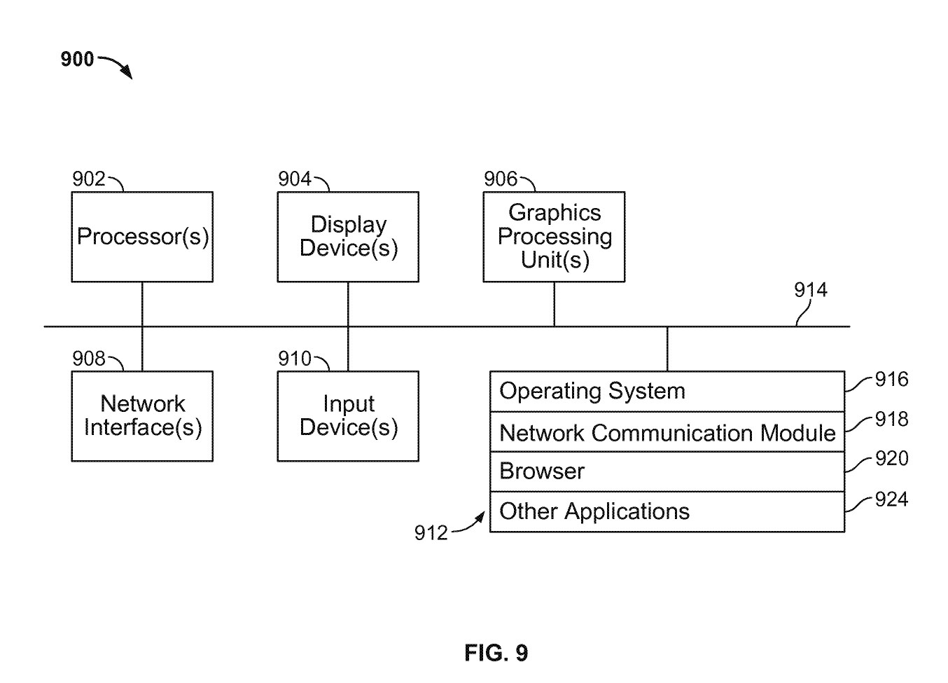

FIG. 1 is a flowchart showing an example method 100 for presenting retrieved data. A user interface is presented 102 (e.g., by system such as system 900 of FIG. 9. The presented user interface can be a graphical interface providing particular information associated with, for example, an operating system or application. For example, the user interface can present information associated with a file system (e.g., a hierarchical file system) including representations of folders, files, applications, or other data stored in the file system (e.g., as icons). Similarly, the user interface can present information associated with a particular application, for example, a browser application.

In some implementations, the system (e.g., system 900) presents a user interface in response to a received input. For example, a user input can include an input navigating to a particular location in a file system hierarchy (e.g., a particular folder such that the system presents a user interface with the contents of the user selected folder), a user input selecting a particular application to execute, or user input to a particular application (e.g., selecting particular resources to retrieve in a browser). Alternatively, in some implementations, the user interface is presented in response to inputs or processes performed by an operating system or executing application. For example, a finder application can reconfigure a user interface in response to external changes in the file system (e.g., when a file in a folder visited by the user is being deleted by some other process or application).

A data request is received 104. In some implementations, an input is received to fetch data from a location and to present the data in a newly drawn user interface. For example, a user can select a particular displayed folder in the current user interface to open. Consequently, an input can be received to fetch the contents of the folder and display them in the user interface. Similarly, a user can request information or a particular action within an application that requires fetched data. For example, a user can initiate a search using a file system search application. In another example, in a mail application, a user can select a message to view that requires the message data to be fetched.

A data fetch is initiated 106 while maintaining the currently displayed user interface. Thus, for example, following a user input requesting data, the current user interface is maintained while the fetch is initiated. For example, when a user selects a folder in a user interface to open, the current user interface showing the folder icon is maintained during initiation of the data fetch. Additionally, in some implementations, the system locks the user interface such that the user can no longer interact with the contents of the user interface once the data request has been received.

A determination is made whether a specified amount of the data is received within a threshold delay period 108. The threshold delay period can be based on one or more factors including hardware constraints and/or empirical data. In some implementations, a minimum threshold delay period can be associated with hardware refresh rates such that the threshold time can not be less than the refresh time. For example, if the display device presenting the user interface has a refresh rate of 60 Hz, then the minimum threshold delay period can be limited by that refresh rate.

Additionally, empirical data can be used to objectively quantify psychological factors associated with frequent changes to a user interface. For example, a rate of user interface change that results in a user noticeable, and undesirable, flicker can be used in determining the delay period. Specifically, when a user interface is drawn and then rapidly replaced or redrawn, a user perceptible flash of flicker can occur. Similarly, an upper bound of time can be determined from objective analysis to identify a time at which a user interface held constant leads a user to believe there is a problem (e.g., that the user interface has become non-responsive). In some implementations, the delay periods are context dependent (e.g., based on a type of information being fetched, a type of placeholder user interface to be presented, hardware being used, etc.)

The specified amount of data can be all of the data to be fetched or a specific portion of the data. For example, if the fetched data is used to display the contents of a particular folder in a file system, the fetched data can include an identification of the contents of the folder, an identification of which items will be visible within the user interface according to the size of the user interface and the method of display (e.g., which icons fit within the an initial view of the user interface and which icons can be viewed by scrolling), and representations of the fetched data (e.g., icons, thumbnails).

In some implementations, the specified amount of data is a particular batch of data. For example, when fetching data corresponding to results of a search performed of a file system (e.g., by a search application), the data is typically fetched over a non-trivial period of time as different portions of the file system are searched. However, to avoid frequent updates to the user interface as the information is received, the specified amount of data needed to draw a new user interface can correspond to a specific number of search results, a particular time delay without newly fetched results, or both.

When the specified amount of data has been received within the threshold time, the system draws 110 a new user interface including at least a portion of the received data to replace the current user interface. In some implementations, if all of the data is received within the threshold time, the full UI representing the data is drawn. For example, if the fetched data is associated with displaying the contents of a particular folder in a file system, the drawn UI can include representations of the items in the folder (e.g., item name, icons, thumbnails, etc.) in particular positions within the user interface.

In some other implementations, the specified amount of data is less than all of the data being fetched such that a portion of the data is displayed in the new user interface. For example, the received data can include an identification of items to display in the user interface and their positions but not the underlying icons. Consequently, the newly drawn user interface can include placeholders for the items, e.g., outlines for icons. In some implementations, the placeholders can be replaced with the corresponding icons as they are received or at predefined intervals (i.e., after each pre-determined period of time has expired).

When the specified amount of data has not been received within the threshold time, the system draws 112 a placeholder user interface to replace the current user interface. In some implementations, the placeholder user interface is a blank user interface, for example, an opaque canvas covering a desktop user interface. In some other implementations, the placeholder user interface is an outline of a new user interface to be populated according to the received data. For example, the placeholder user interface can be an outline of the user interface having a specified height and width. When the data is received, the new user interface is drawn, replacing the placeholder user interface. In some implementations, the entire UI is drawn to replace the placeholder as soon as all the data is fetched. In some implementations, the placeholder UI is replaced/updated as information is fetched (e.g., directory outline UI is updated to include icons as they are fetched). For example, in a mail application a user can select a message to view in which a placeholder user interface shows partial message content (e.g., subject or header information) while the rest of the mail message is being fetched.

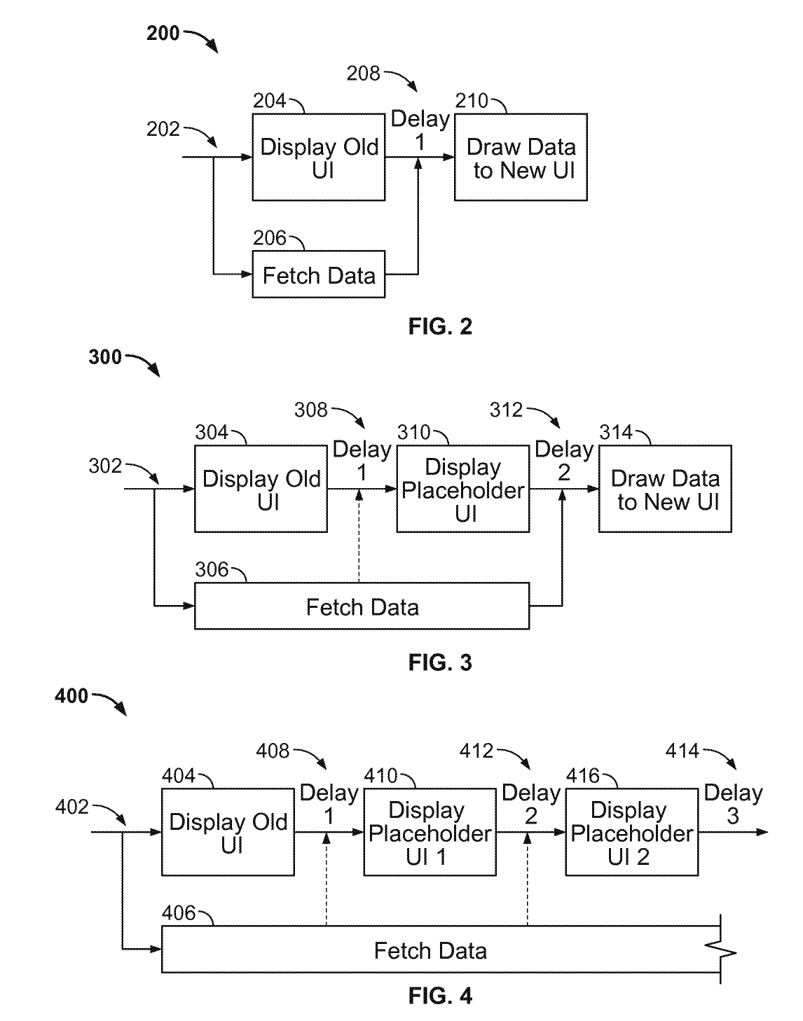

FIGS. 2-4 show block diagrams of example processing pipelines for displaying data.

FIG. 2 is a block diagram showing the operations of an example pipeline 200 for displaying data. When a request for data is received 202 a primary thread continues to display the currently presented user interface 204. Additionally, when the request for data is received 202, the system fetches 206 the requested data in a parallel thread. The currently presented user interface is displayed for up to a specified amount of delay period 208. When the system fetches the data through the parallel thread within the delay period 208, a notice is sent to the primary thread and the system draws a user interface 210 replacing (or updating) the currently presented user interface and including a display of at least a portion of the fetched data (e.g., graphical portions of the fetched data).

FIG. 3 is a block diagram showing the operations of an example pipeline 300 for displaying data. When a request for data is received 302, a primary thread continues to display the currently presented user interface 304. Additionally, when the request for data is received 302, the system fetches 306 the requested data in a parallel thread. The currently presented user interface is displayed for up to a specified first delay period 308. Each specified delay period can be a threshold period having a specified length of time.

If the data is not fetched within the specified first delay period, a placeholder user interface 310 is drawn after the first delay period has expired. Additionally, in some implementations, a second delay period is initiated 312. The second delay period 312 can have a specified time that is equal to the first delay period 308 or a different length of time.

The placeholder user interface 310 can be a generic screen (e.g., a white screen). The generic screen placeholder can be used when the fetched data during the first delay period 308 is not sufficient to draw a partial user interface as the placeholder user interface. Alternatively, if sufficient data has been fetched, a placeholder user interface that partially represents the fetched data can be drawn. As a result, a placeholder user interface with outlines of the items to be displayed in the user interface. For example, the system may not have fetched icons associated with the contents of a folder (e.g., the fetched data can include names and locations for representing items within the user interface, but not the icons themselves). The placeholder user interface can include the file names and graphical representations of the contents of the folder (e.g., dashed boxes representing icons for each item in the folder).

In some implementations, each placeholder icon in the placeholder user interface can be user-interactable such that the user can select the placeholder icons as they normally would when the icons are displayed (e.g., a user can select an item to open, move, or otherwise manipulate without the corresponding icon being present). Additionally, user interaction can reduce data processing by allowing a user to transition to another user interface without completing the data fetch. For example, if a user navigates to another folder within a user interface partially represented in the placeholder user interface (e.g., including names of the items but without icons having been fetched), then the remaining data no longer needs to be fetched.

If the requested data is fetched within the second delay period 312, a notice is sent to the primary thread, which then draws the data to be represented in a new/updated user interface 314.

FIG. 4 is a block diagram showing the operations of an example pipeline 400 for displaying data. When a request for data is received 402 a primary thread continues to display the currently presented user interface 404. Additionally, when the request for data is received 402, a fetche is performed 406 for the requested data in a parallel thread. The currently presented user interface is displayed for up to a specified first delay period 408.

If the data is not fetched within the specified first delay period, a placeholder user interface 410 is drawn after the first delay period has expired. A second delay period is initiated 412. The second delay period 412 can have a specified time that is equal to the first delay period 408 or a different length of time. If additional data, but not a full set of the requested data, is fetched during the second delay period 412, then a third delay period can be initiated 414.

For example, during the second delay period icons associated with some items are fetched but not others (e.g., one or more visible icons can be fetched while other icons having locations that would not be visible in the user interface without scrolling still need to be fetched). Thus, a user interface window generated can have particular dimensions corresponding to the user interface to be generated. This can include scroll bars to accommodate a larger number of items then can be displayed within the viewable area of the user interface. The fetched icons can be prioritized by the ones to be visible within the user interface (e.g., based on a fetched list of items and locations).

During the third delay period 414 an attempt can be made to fetch the remaining data while presenting a second placeholder user interface 416. The second placeholder user interface can be drawn to include a portion of the fetched data (e.g., file names and icons of fetched items). An arbitrary or predetermined number of additional placeholder user interfaces and delay periods can be used until all of the data has been fetched, at which point, the final user interface can be drawn.

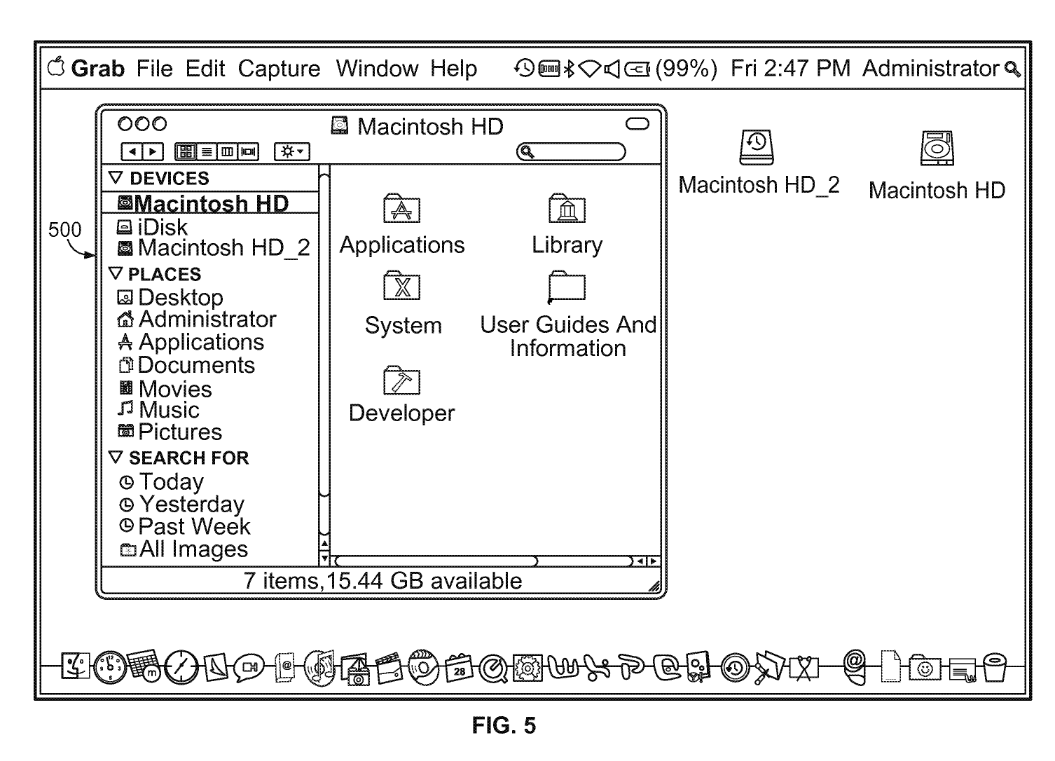

FIGS. 5-8 provide example user interfaces for initiating a fetch of data, presenting placeholder user interfaces, and presenting a new user interface with the fetched data.

FIG. 5 is an example screenshot of user interface 500 from which a request for data is made. In particular, the user interface 500 represents a user interface for a file system directory. The user interface 500 includes representations of several folders that a user can select in order to view the contents of the selected folder. When selected by a user, the system initiates a fetching operation to retrieve data for presenting the contents of the folder (e.g., folder items represented by icons). Once a particular folder is selected, the system maintains the user interface 500 for a specified delay period.

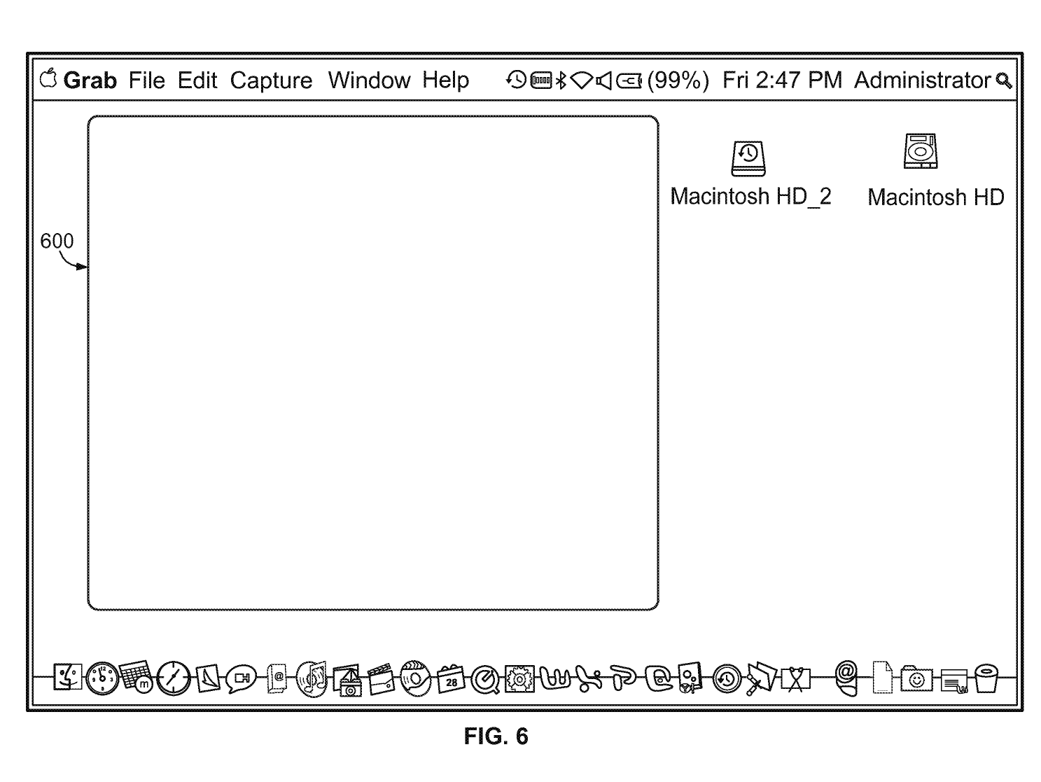

FIG. 6 is an example screenshot of a placeholder user interface 600. The placeholder user interface 600 can be drawn when the requested data has not been received, or an insufficient amount of the requested data has been received, within a specified delay period. In particular, the placeholder user interface 600 provides a blank user interface. In some implementations, the placeholder user interface 600 is maintained for a specified delay period or, alternatively, until the data has been received and a new user interface can be drawn. In some implementations, the placeholder user interface is a blank user interface that encompasses an entire desktop of a client system.

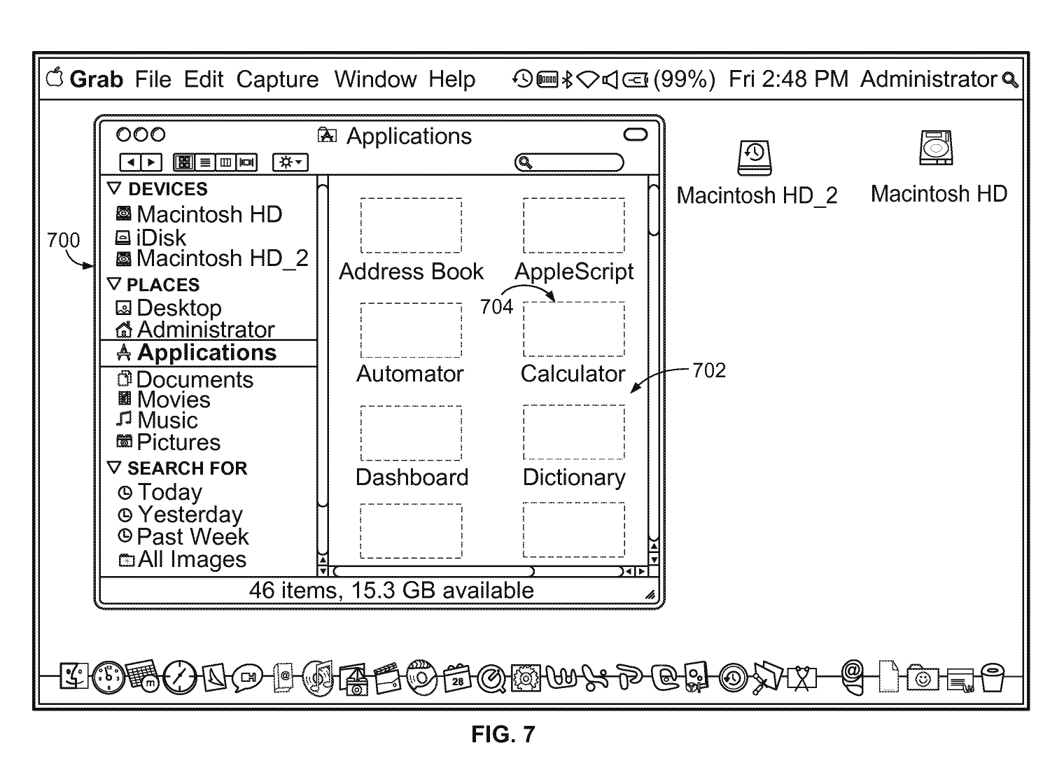

FIG. 7 is an example screenshot of placeholder user interface 700 including partial representations of retrieved data. In particular, the placeholder user interface 700 represents the contents of a folder selected by the user (e.g., an “applications” folder identified in user interface 500 of FIG. 5). The folder items are presented with a name and outline 702 without icons. For example, the names and locations of the items in the folder have been fetched, but the icons have not. Thus, the system generates a placeholder user interface that includes outlines of the folder items. Additionally, in some implementations, the items are user-interactive such that a user can select a particular item outline in order to access content associated with the selected item. For example, a user can selected the calculator object 704 in order to execute the calculator application without the associated icon being presented.

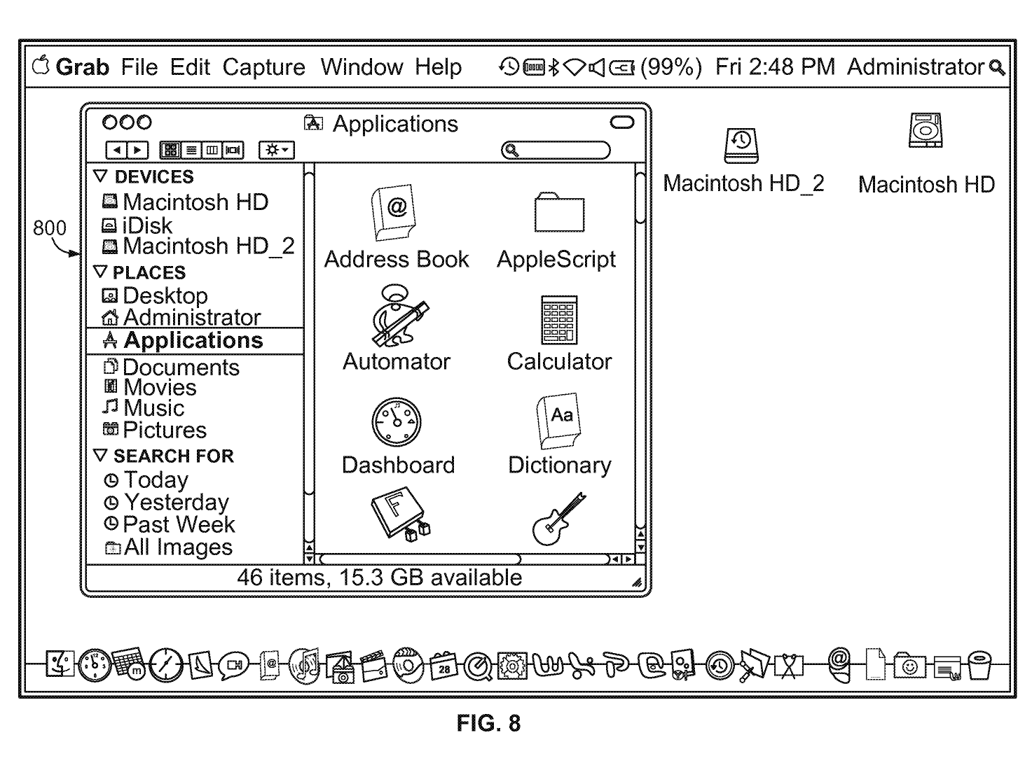

FIG. 8 is an example screenshot of user interface 800 including fetched data. In particular, the user interface 800 shows a user interface drawn after all of the data has been fetched. For example, once the remaining data has been fetched, the placeholder user interface (e.g., placeholder user interface 600 of FIG. 6 or 700 of FIG. 7) can be replaced with the final user interface. As shown in FIG. 8, the user interface 800 displays the contents of an “applications” folder including icons and names identifying application items, which can be selected by a user.

FIG. 9 is an example system architecture 900. The architecture 900 includes one or more processors 902 (e.g., IBM PowerPC, Intel Pentium 4, etc.), one or more display devices 904 (e.g., CRT, LCD), graphics processing units 906 (e.g., NVIDIA GeForce, etc.), network interface 908 (e.g., Ethernet, FireWire, USB, etc.), input devices 910 (e.g., keyboard, mouse, etc.), and one or more computer-readable mediums 912. These components exchange communications and data using one or more buses 914 (e.g., EISA, PCI, PCI Express, etc.).

The term “computer-readable medium” refers to any medium that participates in providing instructions to processor 902 for execution. The computer-readable medium 912 further includes an operating system 916 (e.g., Mac OS®, Windows®, Linux, etc.), network communication module 918, a browser 920 (e.g., Safari®, Microsoft® Internet Explorer, Netscape®, etc.), and other applications 924.

The operating system 916 can be multi-user, multiprocessing, multitasking, multithreading, real-time and the like. The operating system 916 performs basic tasks, including but not limited to: recognizing input from input devices 910; sending output to display devices 904; keeping track of files and directories on computer-readable mediums 912 (e.g., memory or a storage device); controlling peripheral devices (e.g., disk drives, printers, etc.); and managing traffic on the one or more buses 914. The network communications module 918 includes various components for establishing and maintaining network connections (e.g., software for implementing communication protocols, such as TCP/IP, HTTP, Ethernet, etc.). The browser 920 enables the user to search a network (e.g., Internet) for information (e.g., digital media items).

Additionally, the operating system 916, or alternatively separate software, provides various components for performing the various functions for determining whether specified delay periods have occurred and for presenting placeholder user interfaces, as described above with respect to FIGS. 1-8.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
receiving a request for data;
submitting the request while maintaining a currently displayed user interface;
while maintaining the currently displayed user interface, determining whether a specified amount of the data has been received within a threshold delay period;
if the data has been received within the threshold delay period, displaying a new user interface including representations of a portion of the received data; and
if the data has not been received within the threshold delay period, displaying a placeholder user interface.

2. The method of claim 1, further comprising:
drawing representations of received data to the placeholder user interface as the data is received.

3. The method of claim 1, further comprising:
determining whether the data has been received within a second threshold delay period; and
if the data has not been received within the second threshold delay period, drawing a second placeholder user interface replacing the first placeholder user interface.

4. The method of claim 1, where the threshold delay period has a minimum value based on display hardware constraints.

5. The method of claim 1, where the placeholder user interface is a blank screen.

6. The method of claim 1, where the placeholder user interface includes a partial display of the user interface to be drawn for representing the received data.

7. The method of claim 6, where the placeholder user interface includes placeholders for icons, where the data including the icons has not been received.

8. The method of claim 6, where the placeholders for icons include outlines of items in the placeholder user interface to be represented by the corresponding icons.

9. The method of claim 6, where the partially drawn user interface includes representations of items that are user-interactable.

10. The method of claim 9, where a user selection of an item represented in the partially drawn user interface cancels the pending request for data and initiates a new request for displaying data associated with the selection.

11. The method of claim 1, where the placeholder user interface or the new user interface are presented without a flicker effect caused by transitioning from the currently displayed user interface.

12. A method performed by data processing apparatus, the method comprising:
presenting a user interface including one or more folder icons;
receiving a request to present the contents of a folder represented by one of the one or more folder icons;
fetching data for displaying the contents of the folder while maintaining the displayed user interface;
while maintaining the displayed user interface, determining whether a specified amount of the data has been received within a threshold time;
if the data has been received within the threshold time, displaying a new user interface including representations of the folder contents viewable within the dimensions of the new user interface; and
if the data has not been received within the threshold time, displaying a placeholder user interface.

13. A system comprising:
one or more computers configured to perform operations including:
receiving a request for data;
submitting the request while maintaining a currently displayed user interface;
while maintaining the currently displayed user interface, determining whether a specified amount of the data has been received within a threshold delay period;
if the data has been received within the threshold delay period, displaying a new user interface including representations of a portion of the received data; and
if the data has not been received within the threshold delay period, displaying a placeholder user interface.

14. The system of claim 13, further configured to perform operations comprising:
drawing representations of received data to the placeholder user interface as the data is received.

15. The system of claim 13, further configured to perform operations comprising:
determining whether the data has been received within a second threshold delay period; and
if the data has not been received within the second threshold delay period, drawing a second placeholder user interface replacing the first placeholder user interface.

16. The system of claim 13, where the threshold delay period has a minimum value based on display hardware constraints.

17. The system of claim 13, where the placeholder user interface is a blank screen.

18. The system of claim 13 where the placeholder user interface includes a partial display of the user interface to be drawn for representing the received data.

19. The system of claim 18, where the placeholder user interface includes placeholders for icons, where the data including the icons has not been received.

20. The system of claim 18, where the placeholders for icons include outlines of items in the placeholder user interface to be represented by the corresponding icons.

21. The system of claim 18, where the partially drawn user interface includes representations of items that are user-interactable.

22. The system of claim 21, where a user selection of an item represented in the partially drawn user interface cancels the pending request for data and initiates a new request for displaying data associated with the selection.

23. The system of claim 13, where the placeholder user interface or the new user interface are presented without a flicker effect caused by transitioning from the currently displayed user interface.

24. A system comprising:
one or more computers configured to perform operations including:
presenting a user interface including one or more folder icons;
receiving a request to present the contents of a folder represented by one of the one or more folder icons;
fetching data for displaying the contents of the folder while maintaining the displayed user interface;
while maintaining the displayed user interface, determining whether a specified amount of the data has been received within a threshold time;
if the data has been received within the threshold time, displaying a new user interface including representations of the folder contents viewable within the dimensions of the new user interface; and
if the data has not been received within the threshold time, displaying a placeholder user interface.

25. A computer program product, stored on a computer readable medium, comprising instructions that when executed on a server cause the server to perform operations comprising:
receiving a request for data;
submitting the request while maintaining a currently displayed user interface;
while maintaining the currently displayed user interface, determining whether a specified amount of the data has been received within a threshold delay period;
if the data has been received within the threshold delay period, displaying a new user interface including representations of a portion of the received data; and
if the data has not been received within the threshold delay period, displaying a placeholder user interface.

26. A computer program product, stored on a computer readable medium, comprising instructions that when executed on a server cause the server to perform operations comprising:
presenting a user interface including one or more folder icons;
receiving a request to present the contents of a folder represented by one of the one or more folder icons;
fetching data for displaying the contents of the folder while maintaining the displayed user interface;
while maintaining the displayed user interface, determining whether a specified amount of the data has been received within a threshold time;
if the data has been received within the threshold time, displaying a new user interface including representations of the folder contents viewable within the dimensions of the new user interface; and
if the data has not been received within the threshold time, displaying a placeholder user interface.
